(19) United States
(12) Patent Application Publication
(10) Pub. No.: US 2006/0280660 A1
(43) Pub. Date: Dec. 14, 2006

(54) Photocatalytic air purifier

(76) Inventor: Robert Michael Weiss, Calgary (CA)

Correspondence Address: ANTONY C. EDWARDS, SUITE 200 - 270 HIGHWAY 33 WEST, KELOWNA, BC, V1X 1X7, CA

(21) Appl. No.: 11/148,218

(22) Filed: Jun. 9, 2005

(51) Int. Cl. B01J 19/12

(52) U.S. Cl. 422/186.3

(57) ABSTRACT

A photocatalytic air purifier is disclosed wherein the photocatalytic air purifier includes an ultraviolet light source that generates heat and a support member having a photocatalyst coated on a first surface of the support member. The support member is positionable distal to the ultraviolet light source, the support member exposing an optimal amount of surface area to the light source such that such that the light source may irradiate the photocatalyst coated on the first surface of the support member. The heat generated by the light source draws ambient air between the first surface member and the light source by convection such that the first surface is in continuous contact with the ambient air.

### FIELD OF THE INVENTION

The present invention relates to the field of purification systems and more particularly, it relates to a photocatalytic air purifier.

### BACKGROUND OF THE INVENTION

Air quality is an important health concern for many people, especially those with allergies, asthma, and other respiratory sensitivities. In addition to concerns of outdoor air pollution from smog, auto emissions, and factory smoke, indoor air quality also poses a real risk to general and respiratory health. For example, invisible particles in the air which may carry toxic substances may be a great threat to health because they evade the body's filtering mechanisms and penetrate deep into lung tissue where they are absorbed in the body. Other harmful particles such as dust mites, pet dander, mold spores, and pollen, may trigger or exacerbate allergic reactions. Gases in the air are also a major risk factor to respiratory health. For example, volatile organic compounds (VOCs) are gases that are dispersed from cleaning solutions, carpets, building materials and many chemicals commonly used around the home. Virtually all indoor contaminants in the air are organic compounds such as pet dander, dust mites, VOCs, and biological contaminants like bacteria, viruses, and fungi that can be effectively controlled through proper air purification. For example, air filtration systems have been widely available and used in households to control allergens. However, air filtration systems merely trap particles and gases and do not destroy or otherwise deactivate the contaminant.

Other air purification systems have incorporated technologies such as photochemistry to destroy airborne contaminants. Photochemistry, which is a chemical reaction in material caused by exposure to light energy, can break down harmful organic molecules typically found in the air into harmless inert substances. Generally, photochemistry is a process that uses photons in the ultraviolet (UV) spectral range to destroy contaminating organic compounds by breaking down the electron bonding of organic molecules. More specifically, the energy from ultraviolet light waves causes photodissociation of molecular oxygen to form highly reactive oxidizing species which interact with the airborne contaminants by converting them into carbon dioxide and water. However, conventional air purification systems that incorporate photochemical technology are generally costly to purchase, install and/or maintain. They also occupy precious space and the fan and other mechanical parts that draw air into the unit for processing create noise. As such, there is a need for an air purifier that efficiently destroys airborne contaminants and is cost effective and virtually completely silent as it does not require a fan or any similar mechanical parts to draw air into the air purifier. It would also be desirable and advantageous if the air purifier also provides a secondary utilitarian and/or aesthetically pleasing function instead of simply occupying space like a conventional air purification unit.

Applicant is aware of United States Patent Application Publication No. 2004/0213899 to Wang which describes a fluorescent lamp capable of cleaning air. The fluorescent lamp tube is coated with the semiconductor nano crystal anatase titanium dioxide (TiO₂) solution to form a photocatalytic coated fluorescent lamp capable of cleaning air. A small amount of precious metals complex or transition metal oxides on or in the anatase TiO₂ surface increases the visible light photocatalysis efficiency. Although the Wang application describes a fluorescent lamp capable of cleaning air, the TiO₂ coated on the fluorescent lamp tube is an inefficient method of destroying contaminants in the air. For example, the TiO₂ coated fluorescent lamp tube provides a very small surface area for the airborne contaminants to react with the photocatalyst. Insufficient surface area reduces the rate of reaction to convert organic molecules in the air into inert substances.

Applicant is also aware of U.S. Pat. No. 6,135,838 to Wang which describes a UV lamp for air cleaning and treating waste gases wherein the UV lamp includes a glass-fiber-cloth impregnated with a photocatalyst, such as anatase TiO₂, which is then wrapped around and fixed onto a UV lamp tube. The invention also relates to a process for treating waste gases by using the UV lamp for treating waste gas through irradiating UV light therefrom on the surface of the photocatalytic materials to generate free electron and electron hole pairs which can decompose waste gases such as organic or inorganic pollutants in the air into unharmful gases. The Wang patent fails to describe a device that efficiently converts organic molecules in the air into inert substances. The glass-fiber-cloth impregnated with the photocatalyst is wrapped around and fixed onto a UV lamp tube. Insufficient air flow between the UV lamp and the photocatalyst and the small surface area for the airborne contaminants to react with the photocatalyst reduces the rate of reaction to convert organic molecules in the air into harmless substances.

Applicant is also aware of U.S. Pat. No. 5,919,422 to Yamanaka et al. which describes a titanium dioxide photo-catalyzer for deodorizing, cleaning, sterilizing and water purifying operations. A titanium dioxide film is disposed on a substrate and a light-emitting diode that produces ultraviolet light having a wavelength from 360 to 400 nm is disposed adjacent to the titanium dioxide film. The titanium dioxide disposed on the substrate functions as a photocatalyst. The substrate may include a muddler, a decorative box, a bacteria-repelling and deodorizing box, a console box, a fan, an air conditioner, an air purifier, a bacteria-repelling and deodorizing sheet, a vehicle curtain and vehicle blind which function as a light shield for the vehicle, a hanger, a microphone, and a shoe container. The device described in the Yamanaka patent fails to teach or suggest an air purifier device that takes advantage of the primary illumination function of a light source to provide an air purifier having a secondary functional and/or decorative purpose.

As such, there is a need to provide an improved photocatalytic air purifier that overcomes the inadequacies and insufficiencies of the prior art.

### SUMMARY OF THE INVENTION

The present invention provides an improved photocatalytic air purifier having a greater surface area to significantly increase the volumetric rate of reaction between the air and the photocatalyst. The photocatalytic air purifier of the present invention also provides a second utilitarian and/or decorative function.

The photocatalytic air purifier according to the present invention includes an ultraviolet light source wherein the light source generates heat. A support member coated with a photocatalyst on a first surface of the support member is disposed distal to the light source, the support member exposing an optimal amount of surface area to the light source such that the light source may irradiate the photocatalyst coated on the first surface of the support member. The heat generated by the light source draws ambient air between the first surface and the light source by convection such that the photocatalyst coated on the first surface is in continuous contact with the ambient air. Preferably, the photocatalyst coated on the first surface of the support member includes titanium dioxide. The photocatalyst may be a titanium dioxide coating applied onto the first surface of the support member such that the titanium dioxide coating adheres onto the first surface member. In an embodiment of the invention, the photocatalyst may also include a metal oxide such as niobium pentoxide and/or ferrous oxide. Preferably, the light source emits light of wavelength between 320 nm to 400 nm.

In an embodiment of the invention, the support member is a lampshade. The photocatalyst is coated on an inner surface of said lampshade, the lampshade disposed apart from and surrounding the light source such that the light source may irradiate the photocatalyst coated on the inner surface of the lampshade. The heat generated by the light source draws ambient air between the inner surface and the light source by convection such that the photocatalyst coated on the inner surface is in continuous contact with the ambient air. The lampshade is made of a material that is non-reactive with the photocatalyst. Alternatively, the support member may be at least one blade of a fan of a hand dryer wherein the blade is made of a material non-reactive to the photocatalyst. In the further alternative, the support member may also be a window treatment wherein the window treatment is comprised of a material non-reactive to the photocatalyst.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts, and wherein

FIG. 1 is a schematic view of an embodiment of the photocatalytic air purifier according to the present invention.

FIG. 2 is a bottom perspective view of the lampsbade air purifier of FIG. 1.

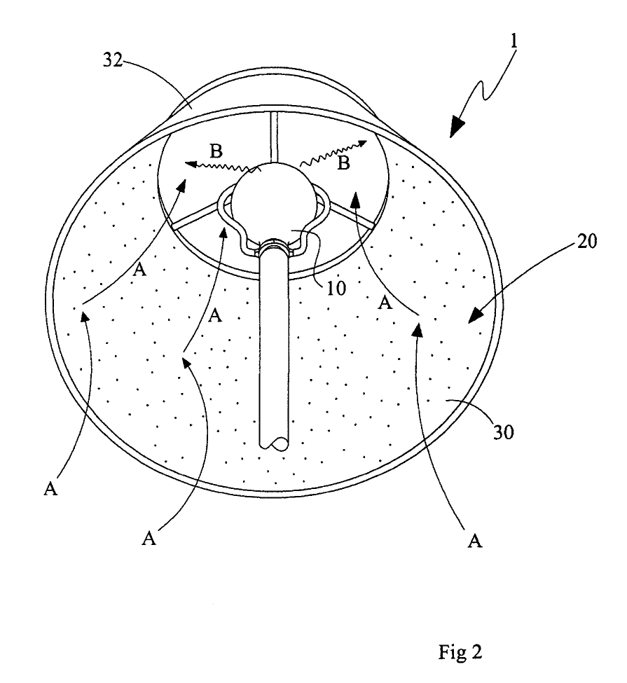

FIG. 3 is a sectional view along line 3-3 in FIG. 1.

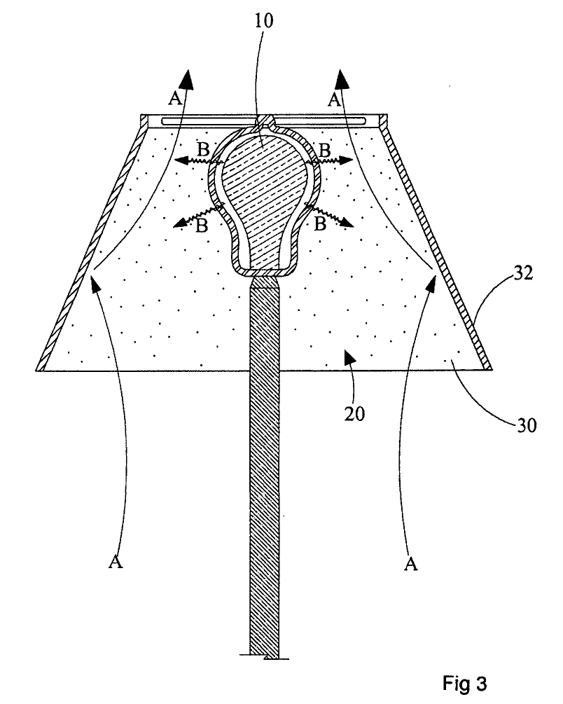

### DETAILED DESCRIPTION OF EMBODIMENTS OF THE INVENTION

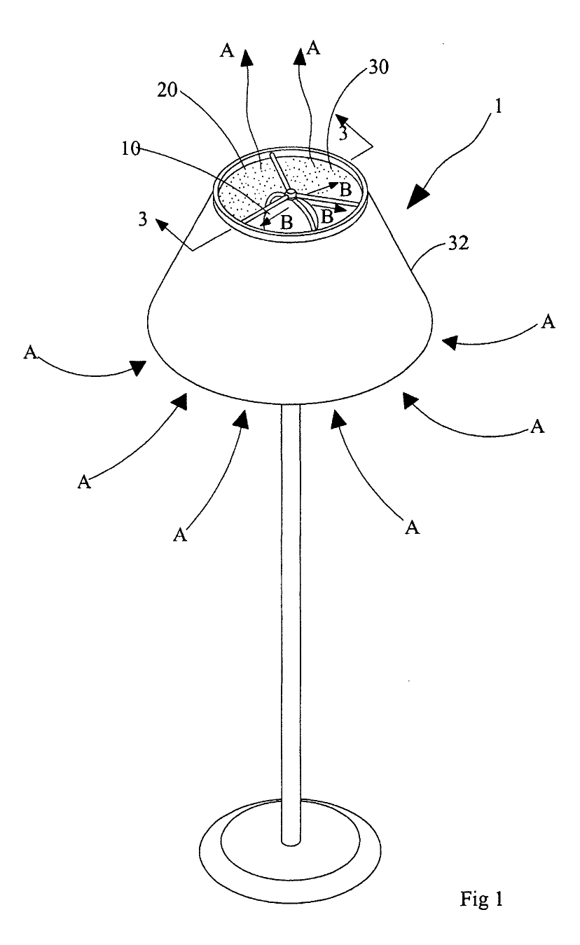

As seen in FIG. 1, the photocatalytic air purifier 1 of the present invention includes an ultraviolet light source 10 such as UV light emitting bulb and a photocatalyst 20 coated on a first surface such as inner surface 30 of a support member such as lampshade 32. Inner surface 30 of lampshade 32 is positioned relative to light source 10 such that photocatalyst 20 (indicated in the illustrations by way of a stippled surface) coated on surface 30 of lampshade 32 is exposable to light source 10 such that light source 10 may irradiate photocatalyst 20. Support member 32 is positionable distal to, that is spaced from light source 10 and, preferably, shade 32 surrounds light source 10 such that light source 10 may irradiate photocatalyst 20. Photocatalyst 20 is in continuous contact with ambient air circulating, for example flowing in directions A, in the airspace between surface 30 and light source 10. In the illustrated embodiment of the invention, which is not intended to be limiting, photocatalytic air purifier 1 is a lamp including a shade 32 made of suitable preferably non-flammable and/or inert materials and coated with photocatalyst 20 on the inner surface 30. Thus when lampshade 32 is detachably mounted on, or adjacent, light source 10, light source 10 may irradiate in direction B photocatalyst 20 coated on the inner surface 30 of lampshade 32.

Light source 10 may be any ultra violet (UV) light source that generates heat. UV light has a wavelength in the range of approximately 200 nm to 400 nm, and is generally invisible to the human eye. The UV spectrum is conventionally arbitrarily divided into three ranges: UVA (wavelength range of 320 nm to 400 nm), UVB (wavelength range of 260 nm to 320 nm), and UVC (wavelength range of 200 nm to 260 nm). UVA is at least partially in the visible range and is the least harmful and most commonly found type of UV light. It has the least energy. In an embodiment of the invention, light source 10 may be an incandescent light source. The conventional incandescent light source produces light when an electric current is passed through a tungsten filament, converting the electricity into light and heat. Conventional incandescent lamps emit very little UV light and do not require UV filtering. Alternatively, light source 10 may be a fluorescent light source which produces UV radiation by the emission of low-pressure mercury gas. A phosphorescent coating on the inside of the fluorscent lamp tubes absorbs the UV radiation. In the further alternative, light source 10 may be a tungsten-halogen light source, which is a variation on the incandescent lamp. Tungsten-halogen light sources contain halogen gas inside a quartz bulb and emit significant UV light which also does not require filtering. In another alternative, light source 10 may be a high intensity discharge (HID) light source which contains a vapor inside a glass that is coated with a fluorescent powder and is much more intense than normal fluorescent light sources. For example, a sodium HID lamp, which has very low UV emissions and generate little heat, may be used. Light source 10 may alternatively be an electrodeless light source which produces a lot of illumination and provides low infrared and UV light. In a further alternative, light source 10 may be a UV light emitting diode (LED) light source. Other UV light sources include but are not limited to xenon lamps, deuterium lamps, mercury-xenon lamps, and remote source lighting.

Photocatalyst 20 may be any compound that has demonstrated photocatalytic properties for the oxidation and destruction of organic contaminants. Such compounds include but are not limited to titanium dioxide (TiO₂), tin oxide (SnO₂), zinc oxide (ZnO), potassium tantalum oxide (KTaO₂), and calcium titanate (CaTiO₃). Preferably, photocatalyst 20 is substantially comprised of TiO₂. TiO₂ is a photocatalyst that has a band gap energy that is equivalent to the photon energy of UV light with a wavelength range of 387 nm to 400 nm. When TiO₂ photocatalyst 20 is irradiated with photons from light source 10, the photons excite an electron on the high energy valence band and promote it to the conduction band, which has very few electrons. The difference in energies between the high energy valence band and the lower energy conduction band is termed the band gap energy. When TiO₂ absorbs a photon of energy equal to or greater than its band gap energy, an electron is promoted from the valence band to the conduction band. An electron vacancy or “hole” is left behind in the valence band. The promoted electron reacts with oxygen and the hole in the valence band reacts with water, such as humidity or moisture in the ambient air, and forms reactive hydroxyl (OH) radicals. When a contaminant in the ambient air contacts photocatalyst 20, the OH radical chemically reacts with the contaminant by abstracting a hydrogen atom from the contaminant. The OH radical thereby oxidizes the contaminant, producing water (H₂O) and carbon dioxide (CO₂). Photocatalyst 20 may be applied onto first surface 30 of support member 32 by way of a conventional TiO₂ coating. The TiO₂ coating may be sprayed, painted, or otherwise adhered onto first surface 30 of support member 32 by conventional means known in the art.

Photocatalyst 20 may also include a co-catalyst comprising a metal oxide such as niobium pentoxide (Nb₂O₅) or ferrous oxide (Fe₂O₃) so as to enhance the ability of photocatalyst 20 to convert organic compounds into inert substances. By modifying the surface of, or doping, photocatalyst 20 with at least one metal, the charge separation of photocatalyst 20 may be enhanced so as to provide more efficient conversion of organic compounds by encouraging formation of unique composites that are normally incompatible. In an embodiment of the invention, photocatalyst 20 is comprised of between 90% to 100% of TiO₂ and 0% to 10% of Nb₂O₅. In another embodiment of the invention, photocatalyst 20 is comprised of between 95% to 100% of TiO₂ and 0% to 5% of Fe₂O₃. In a further embodiment of the invention, photocatalyst 20 is comprised of between 90% to 100% of TiO₂, 0% to 10% of Nb₂O₅, and 0% to 5% of Fe₂O₃

The volumetric rate of reaction increases with increased surface area between the reactants. Advantageously, surface 30 of shade 32 provides as large a surface area as is practical to improve the efficiency of photocatalytic air purifier 1. More specifically, shade 32 provides an optimal amount of surface area on surface 30 for photocatalyst 20 to react with organic contaminants in the ambient air. In an embodiment of the invention, the amount of surface area of surface 30 is limited only by the maximum distance of surface 30 from light source 10 at which the UV light from light source 10 will irradiate photocatalyst 20 coated on surface 30 so as to produce highly active OH radicals for converting the organic compounds to H₂O and CO₂. This will depend on the strength of light source 10 and the shape and position of shade 32 relative to light source 10. In the lampshade example, surface 30 provides a large surface area for photocatalyst 20 to be coated on, thereby increasing the amount of photocatalyst 20 that may come into contact with the ambient airflow that may contain contaminants. Preferably, adequate ambient airflow is maintained such that photocatalyst 20 may continually convert contaminants in the ambient air exposed to photocatalyst 20 when irradiated with light source 10.

Suitable materials for shade 32 may include fibreglass, textiles, plastic, parchment, or glass. The heat generated from light source 10 circulates ambient air containing various contaminants upwardly by convection between light source 10 and photocatalyst 20 coated on support surface 30. Alternatively, the media supporting the photocatalyst may be any conventional window treatment such as horizontal blinds, vertical blinds, and window shutters such that photocatalyst 20 coated on the window treatment may be irradiated by natural sunlight. In the further alternative, the support media may be a conventional hand dryer that incorporates light source 10 within the body of the hand dryer to irradiate photocatalyst 20. Photocatalyst may be coated on at least one of the blades of the fan of the hand dryer or any other interior part that is distal from light source 10.

As will be apparent to those skilled in the art in the light of the foregoing disclosure, many alterations and modifications are possible in the practice of this invention without departing from the spirit or scope thereof. Accordingly, the scope of the invention is to be construed in accordance with the substance defined by the following claims.

What is claimed is:

1. A photocatalytic air purifier comprising:
an ultraviolet light source, said light source generating heat; and
a support member, said support member coated with a photocatalyst on a first surface of said support member, said first surface exposed to said light source;
wherein said support member is mounted so as to be disposed spaced apart from said light source, said support member exposing an optimal amount of surface area to said light source such that said light source may irradiate said photocatalyst coated on said first surface of said support member; and
wherein said heat generated by said light source draws ambient air between said first surface member and said light source by convection such that said photocatalyst coated on said first surface of said support member is in continuous contact with said ambient air.

2. The photocatalytic air purifier of claim 1 wherein said photocatalyst is comprised of titanium dioxide.

3. The photocatalytic air purifier of claim 2 wherein said photocatalyst further comprises a metal oxide.

4. The photocatalytic air purifier of claim 3 wherein said metal oxide comprises niobium pentoxide.

5. The photocatalytic air purifier of claim 2 wherein said metal oxide comprises ferrous oxide.

6. The photocatalytic air purifier of claim 5 wherein said metal oxide further comprises niobium pentoxide.

7. The photocatalytic air purifier of claim 3 wherein said UV light source emits light of wavelength between 320 nm to 400 nm.

8. The photocatalytic air purifier of claim 7 wherein said photocatalyst is a titanium dioxide coating applied onto said first surface member such that said titanium dioxide coating adheres onto said first surface member.

9. The photocatalytic air purifier of claim 1 wherein said support member is a lampshade, said lampshade comprised of a material non-reactive to said photocatalyst.

10. The photocatalytic air purifier of claim 9 wherein said photocatalyst is coated on an inner surface of said lampshade.

11. The photocatalytic air purifier of claim 7 wherein said support member is at least one blade of a fan of a hand dryer, said at least one blade comprised of a material non-reactive to said photocatalyst.

12. The photocatalytic air purifier of claim 7 wherein said support member is a window treatment, said window treatment comprised of a material non-reactive to said photocatalyst.

13. A photocatalytic air purifier comprising:
an ultraviolet emitting bulb which generates heat;
a lampshade having an inner surface and mounted over, so as to surround and be spaced apart from, said lampshade so that said inner surface is exposed to said light source; and
a photocatalyst including titanium dioxide, said photocatalyst coated on said inner surface of said lampshade;
wherein heat generated by said light source draws ambient air between said inner surface and said light source by convection such that said photocatalyst coated on said inner surface is in continuous contact with a flow of ambient air.

14. The photocatalytic air purifier of claim 13 wherein said photocatalyst further comprises a metal oxide.

15. The photocatalylic air purifier of claim 14 said metal oxide comprises niobium pentoxide.

16. The photocatalytic air purifier of claim 14 said metal oxide comprises ferrous oxide.

17. The photocatalytic air purifier of claim 16 wherein said metal oxide further comprises niobium pentoxide.

18. The photocatalytic air purifier of claim 14 wherein said UV light source emits light of wavelength between 320 nm to 400 nm.

19. The photocatalytic air purifier of claim 18 wherein said photocatalyst is a titanium dioxide coating applied onto said inner surface such that said titanium dioxide coating adheres onto said inner surface member.

20. The photocatalytic air purifier of claim 19 wherein said lampshade is comprised of a material non-reactive to said photocatalyst.
